(19) United States
(12) Patent Application Publication
(10) Pub. No.: US 2026/0321923 A1
(43) Pub. Date: Oct. 15, 2026

(54) Contact Element For Electrically Conductively Contacting A Battery Cell Housing

(71) Applicant: Lisa Dräxlmaier GmbH, Vilsbiburg (DE)

(72) Inventors: Michael Steckel, Vilsbiburg (DE); Jakob Retzer, Geisenhausen (DE); Dominikus Wagner, Landshut (DE)

(73) Assignee: Lisa Dräxlmaier GmbH, Vilsbiburg (DE)

(21) Appl. No.: 19/117,043

(22) PCT Filed: Sep. 7, 2023
(86) PCT No.: PCT/EP2023/074528

§ 371 Date: Mar. 30, 2025

(30) Foreign Application Priority Data
Sep. 29, 2022 (DE) 102022125074.1

(51) Int. Cl. H01M 50/56; H01M 50/107

(52) U.S. Cl. CPC H01M 50/56; H01M 50/107

(57) ABSTRACT

Proposed is a contact element for electrically conductively contacting a battery cell housing, comprising: a base plate consisting of an electrically conductive material; multiple spring arms consisting of an electrically conductive material, wherein the spring arms project from the base plate at different locations and together delimit a housing receptacle for receiving an electrically conductive, cylindrical end portion of the battery cell housing; a spring ring which is designed to encompass the spring arms such that they are pressed against a lateral surface of the end portion that is received by the housing receptacle, wherein the spring ring is a slotted ring with two ring ends and has a greater diameter in a pretensioned state than in a relaxed state, wherein, in the pretensioned state, the ring ends abut against one another in the circumferential direction of the spring ring in order to prevent undesired relaxation of the spring ring.

### TECHNICAL AREA

The present invention relates to a contact element for electrically conductive contacting of a battery cell housing. Furthermore, the present invention relates to a method for electrically conductively contacting at least one battery cell housing, a holding system for carrying out this method, a battery cell and a battery module.

### STATE OF THE ART

Batteries in the form of round cells usually comprise a cylindrical battery cell housing made of an electrically conductive material. For electrically conductive contacting of an end section of the battery cell housing, cell connectors can be used, for example, which have a receptacle made up of several spring arms. If the end section is inserted into the holder, the spring arms are pushed apart radially, i.e. pressed against a lateral surface of the end section. The cell connector can be made of a specific alloy that represents a compromise between good electrical conductivity and good elasticity.

DE 10 2019 007 869 A1 describes an example of such a cell connector.

### DISCLOSURE OF THE INVENTION

The object of the invention is to improve the contacting of a battery cell housing. This problem is solved by the subject matter of the independent claims. Advantageous embodiments of the invention are set out in the dependent claims, the following description and the accompanying figures.

A first aspect of the invention relates to a contact element for electrically conductive contacting of a battery cell housing, which comprises a cylindrical end section made of an electrically conductive material. The contact element comprises: a base plate made of an electrically conductive material; a plurality of spring arms made of an electrically conductive material, wherein the spring arms protrude from the base plate at various points and together delimit a housing receptacle for receiving the end section; a spring ring which is designed to span the spring arms such that the spring arms are pressed against an (outer) circumferential surface of the end section received by the housing receptacle, wherein the spring ring is a slotted ring with two ring ends and has a larger diameter in a prestressed state than in a relaxed state, wherein the ring ends abut one another in the circumferential direction of the spring ring in the prestressed state in order to prevent the spring ring from unintentionally relaxing.

It is advisable if the diameter of the pre-tensioned spring ring is large enough to allow it to slide over the spring arms without being further stretched or without the spring arms being excessively bent.

The spring washer or ring can be activated by moving the ring ends laterally, i.e. in the direction of a central axis of the spring ring, until they no longer touch each other, so that the spring ring can relax. The ring ends of the activated, i.e. at least partially relaxed, spring ring can at least partially overlap in its circumferential direction.

The battery cell housing may be configured to accommodate various components of a battery cell, such as a positive electrode, a negative electrode, and a separator separating the electrodes from one another. The battery cell housing can in particular be made of a metallic material and/or be cylindrical. The activatable spring ring can be used, among other things, to prevent excessive bending of the spring arms when inserting the end section into the housing receptacle and/or during operation of the battery cell. Even small inaccuracies, such as a Inaccurate centering of the end section relative to the housing receptacle can have a major influence on the insertion force and deflection of the spring arms.

In other words, the spring ring limits the opening dimension of the housing receptacle and thus the bending force acting on the spring arms. The spring force is therefore not primarily defined by the properties of the spring arms, i.e. their geometry and their material, but by the properties of the separate spring ring. The spring arms can therefore be designed largely independently of the desired spring force, which improves the assembly process.

This also has the advantage that there is a certain degree of freedom in the choice of material for the electrically conductive components of the contact element. For example, the base plate and the spring arms can be made of a material with particularly good electrical conductivity and/or particularly good weldability, but with a lower modulus of elasticity (e.g. B. from copper), whereas the spring ring is made from a material with particularly high elasticity or a particularly high modulus of elasticity, but poorer electrical conductivity and/or poorer weldability (e.g. B. from spring steel). Conventional (one-piece) contact elements are usually made of copper bronze, a material that represents a compromise in terms of electrical conductivity, weldability and elasticity.

The spring ring makes it difficult or impossible for the spring arms to bend outwards. This also increases assembly safety. For example, this can prevent short circuits in a battery module due to spring arms bent outwards.

A second aspect of the invention relates to a method for electrically conductive contacting of at least one battery cell housing. The method comprises: providing a first battery cell housing with a cylindrical first end section made of an electrically conductive material; providing the contact element described above and below, wherein the prestressed spring ring surrounds the spring arms delimiting the housing receptacle; introducing the first end section into the housing receptacle; activating the spring ring by offsetting the ring ends relative to one another in the direction of a central axis of the spring ring until the ring ends no longer abut one another in the circumferential direction of the spring ring, so that the spring ring can relax, wherein the activated spring ring spans the spring arms in such a way that the spring arms are deflected against a (outer) surface of the first end section received by the housing receptacle.

In other words, it is possible that the housing receptacle has a larger diameter when the spring ring is not activated than when it is activated, or that the spring ring presses against the spring arms with a significantly lower force when preloaded than when activated. This simplifies the positioning of the end section in the housing receptacle. Because the spring ring is only activated when the end section is correctly positioned in the housing receptacle, damage to the spring arms can be avoided, which typically occurs when the end section is not positioned accurately in the housing receptacle.

The ring ends can be moved away from each other by applying a first force in the direction of the central axis to a first of the ring ends and by applying a second force opposite to the first force to a second of the ring ends until the ring ends no longer strike each other in the circumferential direction of the spring ring, i.e. can move freely relative to each other in the circumferential direction of the spring ring and thus allow the spring ring to be released.

When the end portion is received by the housing receptacle, the center axis of the spring washer may, for example, be collinear with a center axis of the end portion and/or the battery cell housing and/or the housing receptacle.

A third aspect of the invention relates to a battery cell. The battery cell may have been manufactured using the process described above and below or using another process. The battery cell comprises: a battery cell housing with a cylindrical end portion made of an electrically conductive material; the contact element described above and below, wherein the end portion is received by the housing receptacle and the spring ring surrounds the spring arms such that the spring arms are pressed against an (outer) lateral surface of the end portion received by the housing receptacle.

Various components of a battery cell for storing electrical energy can be arranged in the battery cell housing, such as a positive electrode, a negative electrode and a separator that separates the electrodes from each other. The electrodes and the separator can, for example, be placed on top of each other in strips and wound into a coil be wound up. The battery cell housing can in particular be made of a metallic material and/or be cylindrical.

The battery cell can be a rechargeable (round) cell, for example a lithium-ion cell of a high-voltage battery for supplying power to an electric drive of a vehicle, for example a car, a truck, a bus or a motorcycle.

Features of the battery cell may also be features of the process described above and below (and vice versa).

A fourth aspect of the invention relates to a holding system for carrying out a method according to an embodiment of the second aspect of the invention described below. The holding system comprises: a first holding device for holding a first battery cell housing, wherein the first holding device comprises a first base body with a first opening for inserting. the first battery cell housing and a first projection, wherein the first projection protrudes from an end face of the first base body having the first opening; a second holding device for holding a second battery cell housing, wherein the second holding device comprises a second base body with a second opening for inserting the second battery cell housing and a second projection, wherein the second projection protrudes from an end face of the second base body having the second opening.

It is possible that the first opening connects opposite end faces of the first base body and/or the second opening connects opposite end faces of the second base body. In other words, at least one of the two openings can be a through opening.

The term “basic body” can be understood, for example, as a cuboid body and/or a plastic body.

The term “projection” can be understood, for example, as a rib-or pin-shaped element. For example, the first projection may be made of the same material as the first base body and/or may be manufactured together with the first base body as one and the same part and/or the second projection may be made of the same material as the second base body and/or together with the second base body may have been manufactured as one and the same part.

The holding system allows, among other things, the insertion of the first end section and the activation of the spring ring to be carried out in a single assembly step. This simplifies the assembly process.

A fifth aspect of the invention relates to a battery module which may have been manufactured in a method according to an embodiment of the second aspect of the invention described below or in another method. The battery module comprises: a first battery cell, comprising a first battery cell housing with a cylindrical first end portion made of an electrically conductive material; a second battery cell, comprising a second battery cell housing with a cylindrical second end portion made of an electrically conductive material; the contact element described above and below; the holding system described above and below. The first battery cell housing is inserted into the first opening of the first holding device so that the first end portion protrudes from the first opening. The second battery cell housing is inserted into the second opening of the second holding device. The first end section is received by the housing holder. The spring ring surrounds the spring arms in such a way that the spring arms are pressed against an (outer) surface of the first end section received by the housing receptacle. Furthermore, the second end portion contacts a side of the base plate facing away from the housing receptacle.

In addition, the second end section can be integrally connected to the base plate, for example by welding, soldering or gluing.

It is also possible for the first ring end to be opposite the first projection and/or the second ring end to be opposite the second projection.

Features of the battery module may also be features of the process described above and below (and vice versa).

Embodiments of the invention may be considered to be based on the ideas and findings described below. These embodiments are not to be understood as limiting the invention.

According to one embodiment, each ring end may comprise a stop surface of a defined width in the direction of a central axis of the spring ring. The ring ends that strike each other can touch at their contact surfaces. One of the contacting stop surfaces may be displaceable in the direction of the central axis from an initial position beyond one end of the other stop surface to allow the spring ring to relax, i.e. to allow activation of the spring ring. The width of the stop surfaces can, for example, be at least 2 mm, at least 5 mm or at least 10 mm. The stop surfaces can be the same width or different widths. On the one hand, this prevents the spring ring from being accidentally activated by slightly offsetting the ring ends from each other. On the other hand, this allows for easy activation of the spring ring.

According to one embodiment, the stop surfaces can differ from one another in their width. The wider of the stop surfaces in the starting position can protrude beyond the less wide stop surface on both sides in the direction of the central axis. For example, the wider stop surface can be at least 2 times, at least 5 times or at least 10 times as wide as the narrower stop surface. For example, the widths can differ by at least 2 mm, at least 5 mm or at least 10 mm. In general, the less force is required to move the ring ends, the greater the deviation can be. This prevents one of the stop surfaces from slipping over one end or the other of the other stop surface if the ring ends are only slightly offset from each other. This prevents the spring ring from being accidentally activated.

According to one embodiment, the sections of the wider stop surface projecting beyond the less wide stop surface can have the same width (in the direction of the central axis) in the initial position. In other words, the narrower of the stop surfaces in the starting position can be arranged centrally opposite the wider stop surface. Such a symmetrical arrangement of the stop surfaces simplifies the assembly of the spring washer, since it is then irrelevant which way the spring washer is placed on the spring arms.

It is also possible that one or each of the stop surfaces in the starting position protrudes one-sidedly beyond the other stop surface in the direction of the central axis. According to one embodiment, at least one of the ring ends comprising the stop surfaces can be formed by a longitudinal section of the spring ring that is bent at least twice. The longitudinal section can, for example, be an elongated wire section of the spring ring. This means that the stop surface or surfaces can be provided with little manufacturing effort.

According to one embodiment, the longitudinal section can be bent at a first location by a first bending angle in a first bending direction and at a second location by a second bending angle in a second bending direction. The second location may be between a free end of the longitudinal section and the first location. The stop surface of the respective ring end can be formed by a straight part of the longitudinal section extending between the second point and the free end. The straight part can be orthogonal to its longitudinal direction or oblique to the circumferential direction of the spring ring.

According to one embodiment, the first bending angle and the second bending angle may differ from each other. For example, the bending angles can differ by at least 10%, at least 50% or at least 100%.

According to one embodiment, the first bending direction and the second bending direction may differ from each other.

According to one embodiment, the second bending angle may be greater than, in particular twice as large as, the first bending angle. For example, the first bending angle can be 90 degrees and/or the second bending angle can be 180 degrees.

According to one embodiment, the first bending direction may be opposite to the second bending direction.

According to one embodiment, one of the ring ends can be designed as a cup with a cup opening and the other ring end can be inserted into the cup opening in the prestressed state. The cup thus acts as a kind of closure to temporarily close the slotted ring. Some force may be required to open the lock. This prevents unwanted activation of the spring ring. For example, the other end of the ring can be manually and/or with the help of a tool is pulled and/or pushed out of the cup opening so that the spring ring can relax.

According to one embodiment, the cup opening may have a defined depth and its diameter may become smaller with increasing depth. In other words, the cup can have a cross-section tapering on its inside in the circumferential direction of the spring ring, i.e. it can be conical. This allows the other ring end to be inserted into the cup opening and/or removed from the cup opening more easily without excessive deformation of the spring ring, particularly at its ring ends. The depth of the cup opening can, for example, be between 1 mm and 10 mm. The cup opening can also be deeper.

According to one embodiment, the material of the base plate and/or the spring arms may be copper and/or copper alloy. This allows the electrical conductivity and weldability of the base plate and/or the spring arms to be improved compared to conventional designs, for example made of copper bronze.

According to one embodiment, the material of the spring ring may differ from the material of the base plate and/or the spring arms and/or may be steel, in particular spring steel. This allows an improvement in the elasticity and/or strength of the spring ring.

According to one embodiment, the method may further comprise: providing a second battery cell housing with a cylindrical second end portion made of an electrically conductive material; providing a first holding device for holding the first battery cell housing, wherein the first holding device comprises a first base body with a first opening for inserting the first battery cell housing and a first projection, wherein the first projection protrudes from an end face of the first base body having the first opening; providing a second holding device for holding the second battery cell housing, wherein the second holding device comprises a second base body with a second opening for inserting the second battery cell housing and a second projection, wherein the second projection protrudes from an end face of the second base body having the second opening; inserting the first battery cell housing into the first opening such that the first end portion protrudes from the first opening; inserting the second battery cell housing into the second opening; arranging the holding devices and the contact element such that the base plate (at least partially) lies between the first end section and the second end section (for example between an end face of the first end section and an end face of the second end section), the first end section (for example with its end face) is opposite the housing receptacle, a first of the ring ends is opposite the first projection and a second of the ring ends is opposite the second projection; bringing the base bodies together, wherein the first end section is inserted into the housing receptacle and the spring ring is activated by the first projection pressing against the first ring end in a first force direction and the second projection pressing against the second ring end in a second force direction opposite the first force direction. The second end section can be brought into contact with the base plate by bringing the base bodies together, for example by pressing it against a side of the base plate facing away from the housing receptacle.

Additionally or alternatively, the second end section can be integrally connected to the base plate, in particular welded. The material bonding can take place before and/or after joining and/or during joining. If the second end section is firmly bonded to the base plate before joining, for example before inserting the second battery cell housing into the second opening, this has the advantage that the contact element no longer needs to be additionally held afterwards, which makes assembly easier. The second end section and the base plate can also be soldered and/or glued together.

The base plate can, for example, comprise on its side facing away from the housing receptacle a contacting section which is raised relative to a remaining surface of the base plate for electrically conductive contact with the second battery cell housing and/or an electrical pole of the second battery cell.

The projections should be designed in such a way that the spring washer is only activated when the first end section has been (fully) inserted into the housing receptacle. The projections may be the same or different in shape. For example, the projections can be of different lengths, i.e. they can protrude from the respective end face at different distances. The battery cell housings should sit so firmly in their respective openings that they are not twisted and/or displaced relative to their respective openings or only to a negligible extent when the base bodies are brought together.

### SHORT DESCRIPTION OF THE DRAWINGS

Embodiments of the invention will now be described with reference to the accompanying drawings. Neither the description nor the drawings are to be construed as limiting the invention.

FIG. 1 shows a perspective view of a contact element according to a first embodiment of the invention with prestressed spring ring.

FIG. 2 shows a perspective view of the contact element according to the first embodiment with activated spring ring.

FIG. 3 shows a perspective view of a contact element according to a second embodiment of the invention with prestressed spring ring.

FIG. 4 shows a perspective view of the contact element according to the second embodiment with activated spring ring.

FIG. 5 shows a side view of a battery module according to an embodiment of the invention.

FIG. 6 shows a perspective view of a first holding device of a holding system according to an embodiment of the invention.

FIG. 7 shows a perspective view of a second holding device of a holding system according to an embodiment of the invention.

The drawings are purely schematic and not to scale. If the same reference symbols are used in different drawings, these reference symbols designate the same or equivalent features.

### EMBODIMENT(S) OF THE INVENTION

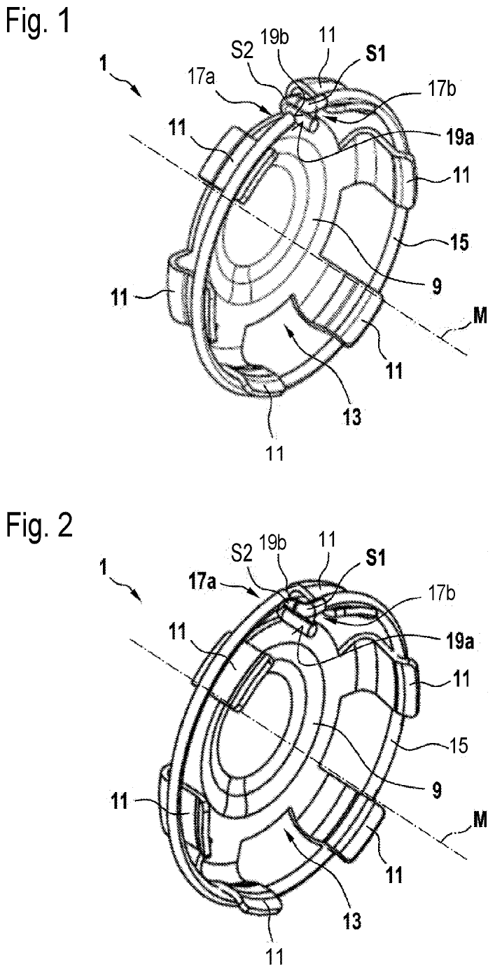

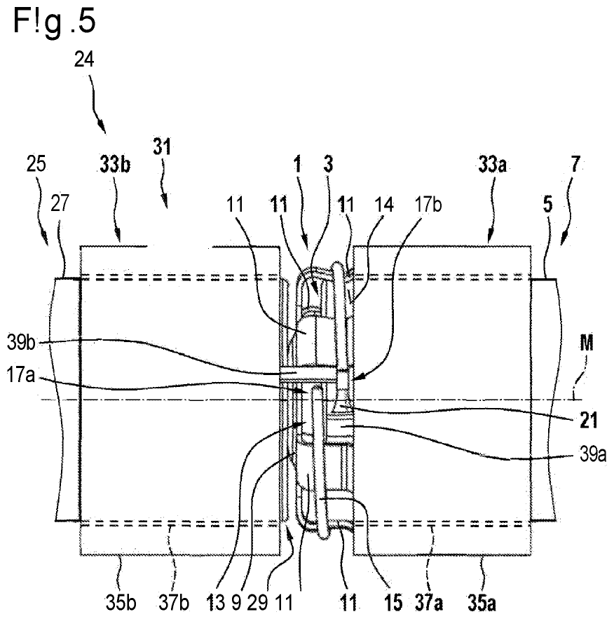

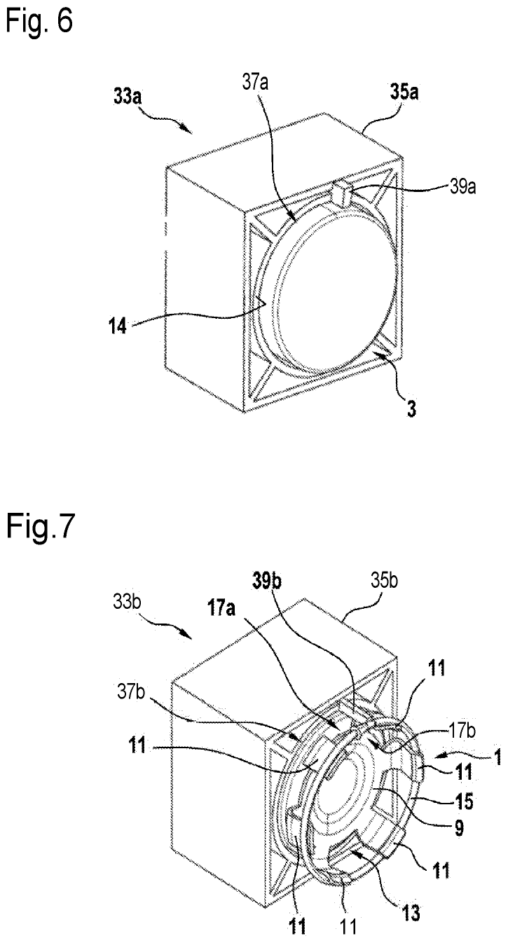

FIG. 1 shows a contact element 1 for electrically conductive contacting of a cylindrical end section 3 of a battery cell housing 5 of a battery cell 7, here a round cell (see FIG. 5 and FIG. 6), for example a lithium-ion round cell for a battery module of an electrically powered vehicle in the form of a car, a truck, a bus or a motorcycle. The end section 3 can, for example, be an electrically conductive cap for closing the battery cell housing 5. The cap can act as a first electrical pole of the battery cell 7.

In this example, the contact element 1 comprises a disc-shaped base plate 9, from the outer contour of which several, here six, spring arms 11 protrude in a star shape, i.e. radially outwards. 516 The spring arms 11 are evenly distributed in the circumferential direction of the base plate 9. The free ends of the spring arms 11 are each bent in the same direction by the same bending angle, here by approximately 90°. Each spring arm 11 is therefore angular. The bent ends of the spring arms 11 together define a housing receptacle 13 into which the end section 3 can be inserted, so that the bent ends of the spring arms 11 are opposite different points of an outer surface 14 of the end section 3 inserted into the housing receptacle 13.

It is possible that the diameter of the housing receptacle 13 in the unloaded state of the spring arms 11 is larger than the diameter of the end section 3, for example by at least 10%. Alternatively, the diameter of the housing receptacle 13 may be slightly smaller than the diameter of the end section 3, so that a certain amount of force may be required to insert the end section 3 into the housing receptacle 13.

The base plate 9 and the spring arms 11 can, for example, be made from the same piece of sheet metal by punching and/or forming.

The bent ends of the spring arms 11 are surrounded by a spring ring 15 in the form of a slotted ring with a first ring end 17a and a second ring end 17b. In the simplest case, the spring ring 15 can be formed, as here, by a correspondingly bent piece of wire.

It is possible that each of the bent ends of the spring arms 11 has an elongated

Recess for receiving a longitudinal section of the spring ring 15, each recess receives another longitudinal section of the spring ring 15. This can, for example, prevent the spring ring 15 surrounding the spring arms 11 from falling off or jumping off the spring arms 11 during assembly of the contact element 1.

FIG. 1 shows the spring ring 15 in the preloaded state. The ring ends 17a, 17b abut each other in the circumferential direction of the spring ring 15 and thus prevent the spring ring 15 from relaxing.

FIG. 2 shows the spring ring 15 in the activated, i.e. at least partially relaxed, state. In this case, the ring ends 17a, 17b are offset from one another laterally, i.e. in the direction of a central axis M of the spring ring 15, compared to the prestressed state. In addition, the ring ends 17a, 17b overlap in the circumferential direction of the spring ring 15.

The spring ring 15 is shaped such that the spring arms 11 are pressed radially inwards with a certain spring force, i.e. with a certain contact pressure, against the outer circumferential surface 14 of the end section 3 received by the housing receptacle 13, by activating the spring ring 15. This enables secure contact with the battery cell housing 5 (see FIG. 5). On the other hand, the diameter of the spring ring 15 in the preloaded state can be so large that the spring ring 15 does not press against the spring arms 11 or presses with a significantly lower spring force than in the activated state. This has the effect that the end section 3 can be positioned with greater clearance in the housing receptacle 13 without the spring arms 11 being subjected to excessive stress.

As shown in FIG. 1 and FIG. 2, one of the two ring ends 17a, 17b, here the second ring end 17b, can be bent in an S-shape (also called S-bend). For this purpose, for example, a longitudinal section of the spring ring 15 can be bent at a first point S1 by 90° in a first bending direction and at a second point S2, which lies between the first point S1 and a free end of the longitudinal section, by 180° in a second bending direction opposite to the first bending direction. A straight part of the longitudinal section extending between the second point S2 and the free end can function as a first stop surface 19a for the first, here non-bent ring end 17a. As can be seen in FIG. 1, the first ring end 17a can touch the stop surface 19a with its end face 19b in the preloaded state (the end face 19b thus functions as a second stop surface 19b for the second ring end 17b). The stop surfaces 19a, 19b can have different widths when viewed in the direction of the central axis M. For example, the wider stop surface 19 a may be at least 2 times or at least 4 times as wide as the less wide stop surface 19b.

As can be seen in FIG. 1, the wider stop surface 19a can, in an initial position, protrude in the direction of the central axis M on both sides beyond the less wide stop surface 19b. The sections of the wider stop surface 19a projecting beyond the less wide stop surface 19b can be essentially of the same width.

The spring ring 15 can be activated by moving one of the stop surfaces 19a, 19b, starting from the initial position, beyond one end of the other stop surface 19a or 19b, so that the ring ends 17a, 17b no longer interfere with each other in the circumferential direction of the spring ring 15 and the spring ring 15 can relax, i.e. contract (see FIG. 2).

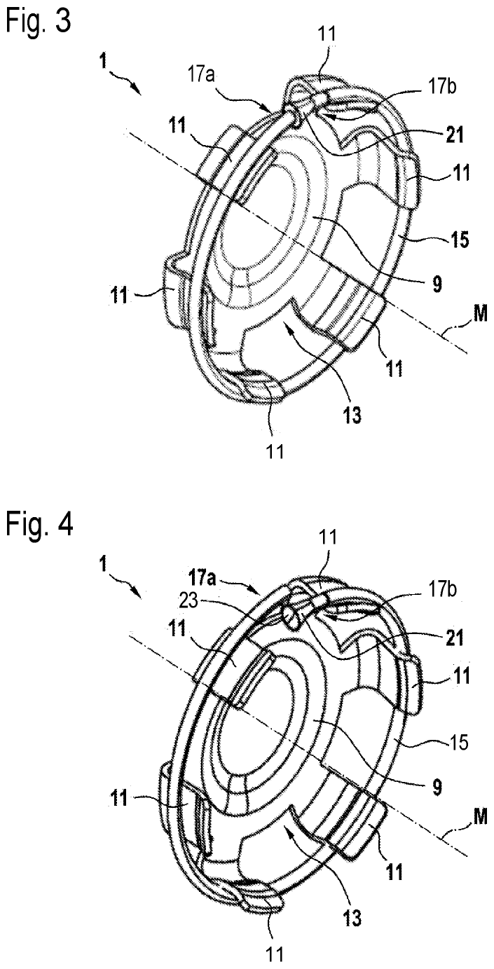

FIG. 3 and FIG. 4 show an alternative embodiment of the contact element 1, in which the two ring ends 17a, 17b are positively and non-positively connected to one another in the prestressed state by means of an unlockable closure. For this purpose, the second ring end 17b comprises a cup 21 with a conical cup opening 23, the cross-section of which tapers with increasing depth. The first ring end 17a is inserted into the cup opening 23 in the prestressed state (see FIG. 3). In the activated state, however, the first ring end 17a is located outside the cup 21 (see FIG. 4). The cup opening 23 has a certain depth, so that the first ring end 17a inserted therein can only be guided out of the cup opening 23 with a certain amount of force, for example by laterally displacing the ring ends 17a, 17b in the direction of the central axis M using a suitable tool (see FIG. 5, FIG. 6 and FIG. 7).

During the manufacture of the battery cell 7, the end section 3 can first be inserted into the housing receptacle 13 surrounded by the prestressed spring ring 15. The spring ring 15 can then be activated by moving the ring ends 17a, 17b towards each other in the direction of the central axis M so that they no longer strike each other. The activated spring ring 15 surrounds the spring arms 11 with a specific spring force, by means of which the spring arms 11 are pressed with a specific contact pressure against the outer surface 14 of the end section 3 inserted into the housing receptacle 13. FIG. 5 shows a battery module 24 with the battery cell 7 as a first battery cell 7 and a second battery cell 25, which comprises a second battery cell housing 27 with a cylindrical second end portion 29. The second battery cell 25 can be designed as a round cell in the same or similar manner as the first battery cell 7.

At least the end sections 3, 29 can be made of a metallic material, so that the battery cells 7, 25 can be electrically conductively contacted via their respective end sections 3 and 29. The battery cell housings 5, 27 can also be made entirely of a metallic material.

The battery module 24 may have been manufactured using a holding system 31 in the method described below. The holding system 31 can be a component of the (finished) battery module 24.

The holding system 31 comprises a first holding device 33a (see FIG. 6) for holding the first battery cell housing 5 and a second holding device 33b (see FIG. 7) for holding the second battery cell housing 27, which can be handled separately from the first holding device 33a. The holding devices 33a, 33b can also be referred to as cell frames.

Each holding device 33a, 33b comprises a base body 35a or 35b with an opening 37a or 37b for inserting at least a portion of the respective battery cell housing 5 or 27, here a through opening which connects opposite end faces of the respective base body 35a or 35b. A first projection 39a projects from an end face of a first base body 35a, at which a first opening 37a ends. A second projection 39b projects from an end face of a second base body 35b, at which a second opening 37b ends.

In the method, the battery cell housings 5, 27 are first inserted into the respective openings 37a and 37b. The first battery cell housing 5 is inserted into the first opening 37a in such a way that the first end section 3 projects beyond the first opening 37a on the end face of the first base body 35a having the first projection 39a. The second battery cell housing 27, however, can be inserted into the second opening 37b in such a way that an end face of the second end section 29 in the Is substantially flush with the end face of the second base body 35b having the second projection 39 b or projects only slightly, for example by less than 10 mm or less than 5 mm.

Subsequently, the holding devices 33a, 33b and the contact element 1 are positioned relative to one another such that the housing receptacle 13 is opposite an end face of the first end section 3, a side of the base plate 9 facing away from the housing receptacle 13 is opposite the end face of the second end section 29, the first projection 39a is opposite the first ring end 17a and the second projection 39b is opposite the second ring end 17b, here a section of the second ring end 17b adjacent to the cup 21.

As can be seen in FIG. 5, the first projection 39a can differ significantly in length from the second projection 39b, for example, it can be significantly shorter than the second projection 39b. In this example, the first projection 39a is just half as long as the second projection 39b. Next, the holding devices 33a, 33b are moved towards each other along a mounting axis, which here corresponds to the central axis M, until the end section 3 is completely inserted into the housing receptacle 13 and, in addition, the second end section 29 touches the base plate 9 with its front side, for example is pressed against the base plate 9 with a certain contact pressure. The ring ends 17a, 17b are displaced relative to one another in the direction of the central axis M by the projections 39a, 39b moving towards one another until the first ring end 17a jumps out of the cup 21 and the spring ring 15 snaps shut, i.e. is activated.

It is possible for the second end portion 29 and the base plate 9 to be welded together, for example by laser welding, before the holding devices 33a, 33b are brought together, in particular before the second battery cell housing 27 is inserted into the second opening 37b. This simplifies the further assembly of the battery module 24.

The battery module 24 may also comprise two or more than two assemblies, each composed of a holding system 31, two battery cells 7, 25 and a contact element 1. In this case, the battery cells and/or the contact elements of different assemblies can be electrically connected to each other, for example to. To connect battery cells of different assemblies in series and/or parallel.

Depending on the embodiment, the method steps described above can also be carried out in a different order.

Finally, it should be noted that terms such as “comprise”, “comprise”, “include”, “with”, etc. do not exclude other elements or steps, and indefinite articles such as “a” or “an” do not exclude pluralities. It is further noted that features or steps described with reference to one of the above embodiments may also be used in combination with features or steps described with reference to other of the above embodiments. Reference signs in the claims are not to be understood as a limitation of the invention.

### LIST OF REFERENCE SYMBOLS

1 contact element
3 first final section
5 first battery cell housing
7 first battery cell
9 Base plate
11 Spring arm
13 Housing mount
14 lateral surface
15 spring ring
17a first ring end
17b second ring end
19a first stop surface
19b second stop surface
21 Mug
23 Cup opening
24 Battery module
25 second battery cell
27 second battery cell housing
29 second final section
31 Holding system
33a first holding device
33b second holding device
35a first basic body
35b second basic body
37a first opening
37b second opening
39a first ledge
39b second projection
M central axis
51 first place
52 second place

1. A contact element for electrically conductively contacting a battery cell housing, wherein the battery cell housing comprises a cylindrical end portion made of an electrically conductive material, wherein the contact element comprises:
a base plate made of an electrically conductive material,
a plurality of spring arms made of an electrically conductive material, wherein the plurality of spring arms project from the base plate at various points and together delimit a housing receptacle configured to receive the end section;
a spring ring configured to clamp around the spring arms such that they are pressed against a lateral surface of the end cut-off received by the housing receptacle, the spring ring comprising a slotted ring with two ring ends and a pretensioned state, the ring ends striking against one another in the circumferential direction of the spring ring in the pretensioned state in order to prevent the spring ring from unintentionally relaxing.

2. The contact element according to claim 1,
wherein each of the two ring ends comprises a stop surface of a defined width in a direction of a center axis of the spring ring and the two ring ends abutting against each other touch each other at their stop surface; and
wherein one of a contacting stop surfaces is displaceable in the direction of the center axis from an initial position beyond one end of an other stop surface to enable the spring ring to relax.

3. The contact element according to claim 2,
wherein the stop surfaces deviate from each other along their width;
wherein a wider stop surface of the stop surfaces located in the initial position projects beyond a less wide stop surface on both sides in the direction of the center axis.

4. The contact element according to claim 3,
wherein the sections of the wider stop surface projecting beyond the less wide stop surface have the same width in the initial position.

5. Contact element (1) according to one of the two claims 2 to 4,
wherein at least one of the ring ends (17a, 17b) comprising the stop surfaces (19a, 19b) is formed by an at least two-fold longitudinal section of the spring ring (15)

6. The contact element according to claim 5,
wherein the longitudinal section is bent at a first location through a first bending angle in a first bending direction and at a second location through a second bending angle in a second bending direction;
wherein the second location lies between a free end of the longitudinal section and the first location;
wherein the stop surface of the respective ring end is formed by a straight part of the elongated section extending between the second location and the free end.

7. The contact element according to claim 6,
wherein the first bending angle and the second bending angle differ from one another; and/or
wherein the first bending direction and the second bending direction differ from one another; and/or
wherein the second bending angle is greater than, in particular twice as great as, the first bending angle; and/or wherein the first bending direction is opposite to the second bending direction.

8. The contact element according to claim 1,
wherein one of the ring ends is formed as a cup having a cup opening and the other ring end is inserted into the cup opening in the prestressed state.

9. The contact element according to claim 8,
wherein the cup opening comprises a defined depth and is configured to become smaller in diameter with increasing depth.

10. The contact element according to claim 1,
wherein the material of the base plate and/or the spring arms is copper and/or copper alloy; and/or
wherein the material of the spring ring differs from the material of the base plate and/or the spring arms and/or is steel, or spring steel.

11. A method for electrically conductive contacting of at least one battery cell housing, wherein the method comprises:
providing a first battery cell housing having a cylindrical first end section (3) made of an electrically conductive material;
providing the contact element, wherein the prestressed spring ring surrounds the spring arms defining the housing receiver;
inserting the first end section into the housing receiver;
activating the spring ring by displacing the ring ends towards one another in the direction of a center axis of the spring ring until the ring ends no longer strike against one another in the peripheral direction of the spring ring, so that the spring ring can relax, the activated spring ring encompassing the spring arms in such a way that they are pressed against a lateral surface by the housing receiver received of the first end section.

12. A method according to claim 11, further comprising:
providing a second battery cell housing having a cylindrical second end portion made of an electrically conductive material;
providing a first holding device for holding the first battery cell housing-wherein the first holding device comprises a first base body having a first opening for inserting the first battery cell housing and a first projection, wherein the first projection protrudes from an end face of the first base body having the first opening;
providing a second holding device for holding the second battery cell housing wherein the second holding device comprises a second base body having a second opening for inserting the second battery cell housing and a second projection (39b), wherein the second projection (39b) protrudes from an end face of the second base body (35b) that has the second opening (37b);
inserting the first battery cell housing (5) into the first opening (37a) so that the first end section (3) projects out of the first opening (37a);
inserting the second battery cell housing (27) into the second opening (37b);
arranging the holding devices (33a, 33b) and the contact element (1) in such a way that:
the base plate (9) is located between the first end section (3) and the second end section (29), the first end section (3) is located opposite the housing receiver (13), a first (17a) of the ring ends (17a, 17b) is located opposite the first projection (39a), a second (17b) of the ring ends (17a, 17b) is located opposite the second projection (39b);
bringing together the base bodies (35a, 35b), wherein the first end section (3) is introduced into the housing receptacle (13) and the spring ring (15) is activated in that the first projection (39a) presses against the first ring end (17a) in a first force direction and the second projection (39b) presses against the second ring end (17b) in a second force direction opposite to the first force direction; wherein the second end section (29) is brought into contact with the base plate (9) by the base bodies (35a, 35b) are brought together and/or is connected in a materially integral manner, in particular is welded, to the base plate (9).

13. (canceled)

14. (canceled)

15. (canceled)
